(19) United States
(12) Patent Application Publication
(10) Pub. No.: US 2015/0039352 A1
(43) Pub. Date: Feb. 5, 2015

(54) SYSTEM AND METHOD FOR BLIND-RATING OF RISK TO COLLATERAL IN A SECURED TRANSACTION

(71) Applicant: G.D. van Wagenen Financial Services, Inc., Eden Prairie, MN (US)

(72) Inventor: Randall Rempp, Eden Prairie, MN (US)

(73) Assignee: G.D. van Wagenen Financial Services, Inc., Eden Prairie, MN (US)

(21) Appl. No.: 14/452,099

(22) Filed: Aug. 5, 2014

Related U.S. Application Data
(60) Provisional application No. 61/862,141, filed on Aug. 5, 2013.

(51) Int. Cl. G06Q 40/08

(52) U.S. Cl. CPC G06Q 40/08
USPC 705/4

(57) ABSTRACT

A method for insuring against collateral or property damage in a secured transaction includes monitoring the insurance status of each individual loan or lease. If insurance is not maintained as agreed by the borrower or lessee, an insurance policy is obtained with the premium for said insurance determined using a blind rating method. Information known about the collateral, as well as other criteria, are weighted and calculated to determine a blind rating score. The blind rating score is then used to determine the premium for replacement insurance policy. A system for implementing a Method includes a property database and a blind rating criteria database.

### CROSS REFERENCE TO RELATED APPLICATIONS

This application is a Non-Provisional Application of co-pending U.S. Provisional Application No. 61/862,141, filed Aug. 5, 2013, which is incorporated herein by reference.

### FIELD OF INVENTION

The present invention relates to methods and systems for establishing property insurance premiums. More particularly, the present invention relates to a system and method for establishing the premium for force-placed insurance of property serving as collateral in a secured loan transaction.

### BACKGROUND OF THE INVENTION

A secured loan transaction, such as a mortgage or other type of loan, requires the borrower to pledge an asset as collateral to secure the payment of the loan. If the borrower fails to comply with the terms of the loan, the lender has the ability to foreclose on the loan and assume ownership of the asset to satisfy, even if partially, the loan obligations. A similar type of transaction is a lease transaction in which the lessor is pledged legal title to the leased property. When the lessee completes its obligations under the lease agreement, the lessee has the option to purchase and own the leased property.

As can be surmised, it is very important for the lessor or lender to ensure that the collateral property be as protected as possible during the entire term of the transaction so as to provide the maximum security. Accordingly, it is almost always a requirement in collateralized secured transactions for the borrower or lessee to maintain adequate insurance on the collateral property to protect against casualty loss.

To ensure that adequate insurance is maintained in such transactions, lenders and lessors are entitled to, and periodically do, review public and private records evidencing that adequate insurance is being maintained on the property. If a lender or lessor discovers that insurance coverage on the property has lapsed, or inadequate insurance is being provided, the lender or lessor is normally entitled to purchase insurance for the property at the expense of the lessee or borrower. This type of insurance is known as “force-placed” insurance.

One common characteristic of force-placed insurance is that it is generally much more expensive than insurance procured by the borrower or lessee directly. The principal reason for the added expense is that a traditional insurance application is not filed in connection with the property and therefore the insurer must underwrite the policy without knowledge of much information normally collected in order to calculate the premium. Generally, this means that the insurer calculates the premium for the insurance based on public records related to the property and on the insurance value required under the secured transaction.

There are multiple factors that dictate the high price of force-placed insurance.

First, because such little information is known by the insurer, and the insurer must be conservative in evaluating the risk, the insurer may rate the policy under a “worst case scenario”. Second, because the insurance premium is the responsibility of the borrower or lessee, there is no incentive for the lender or lessor to seek competitive bids for the insurance policy. Third, force-placed insurers are not traditional insurers and may be subject to lower volume, higher costs and lower efficiency in their underwriting operations. These factors, combined with others not mentioned here, frequently result in force-placed insurance policies with premiums that are disproportionately high relative to the risk they are insuring.

### SUMMARY OF INVENTION

In a first embodiment the invention includes a method and system for blind rating of a collateral property and setting of a premium for insurance of the collateral property by creating a database populated with blind rating criteria and searchable to identify the blind rating criteria applicable to a particular property and/or a particular insured. A lookup table is created which correlates a blind rating criteria score for a particular property and/or a particular insured with a risk level assessment and a corresponding insurance premium value. The minimum level of insurance that must be maintained in force for the collateral property is determined.

The invention includes periodically monitoring the actual level of insurance coverage in place for the collateral property to detect when such insurance coverage has lapsed or has decreased below the required minimum level. If the actual level of insurance for the collateral property lapses, or falls below the required minimum level, the system queries the database for blind rating criteria pertinent to the collateral property and/or insured. Blind rating data applicable to the database query in the immediately preceding step is collected and used in calculating a blind rating criteria score by entering the collected blind rating data into a formula that assigns a given weight to each piece of data. The blind rating criteria score is correlated with a premium value and issuing an insurance policy to the collateral property for the minimum required level of insurance and charging the correlated premium to the insured. The system of the present invention consists of one or more computers adapted and programmed to perform, or assist in the performance of each of the steps described above.

In another embodiment, the invention includes a method of blind rating of a collateral property and setting of a premium for insurance of the collateral property. In this embodiment, the inventive method includes communicating instructions by a system having a data processor to store property data in a first database and storing among said property data a record of said property as possessed by a possessor making payment to an owner of said property for said possession. The method also includes storing among said property data an insurance status associated with said property wherein said insurance status indicates at least whether said property is in included in an insurance policy and storing among said property data a minimum standard for said insurance status maintained by said possessor on said property. Monitoring is performed by said data processor to determine the insurance status of said property as maintained by said possessor on said property.

When the insurance status of said property falls below the minimum standard, the data processor calculates a property risk level score. The property risk level score is correlated with an insurance product which meets the minimum standard for insurance (and associated premium). The correlated insurance product is then issued for the collateral property with the premiums being charged to the borrower or lessee.

In this embodiment, the minimum standard is a predefined value for said policy limit such that said insurance status would fail to meet said minimum standard if the insurance policy associated with said property in said insurance database has a policy limit that fails to meet said predefined value. The insurance status further indicates a deductible of said insurance policy for said property and said minimum standard is a maximum quantity for said deductible.

The property risk level score is calculated using at least one risk level score for at least one of a plurality of blind rating criteria stored in a second database. Calculating said property risk level score comprises calculating at least one risk level score for at least one of a plurality of blind rating criteria stored in a second database. Calculating said property risk level score can comprise calculating a risk level score for each of a plurality of blind rating criteria stored in a second database and selecting the highest of the plurality of risk level scores. Alternatively, calculating said property risk level score can comprise calculating a risk level score for each of a plurality of blind rating criteria stored in a second database and averaging the plurality of risk level scores. Calculating said property risk level score cam also comprise calculating a risk level score for each of a plurality of blind rating criteria stored in a second database and combining the plurality of risk level scores. In one embodiment, the plurality of blind rating criteria are weighted by said processor.

The invention also includes a computer system for the blind rating of a collateral property and setting of a premium for insurance of the collateral property. The system includes a processing device in communication with at least a first and second database and a memory device. The first database contains information related to the collateral property including at least an insurance status and a minimum standard for insurance maintained by said possessor on the collateral property. The second database contains information related to a plurality of predetermined blind rating criteria relating to the risk of loss at the collateral property. The memory device contains instructions that when executed by the processing device result in (1) comparing the insurance status and the minimum standard for insurance; (ii) calculating, responsive to the insurance status falling below the minimum standard for insurance, a property risk level score; (iii) correlating the property risk level score to an insurance product that meets the minimum standard for insurance; and (iv) obtaining the insurance product to cover the collateral property.

### BRIEF DESCRIPTION OF THE DRAWINGS

For a fuller understanding of the invention, reference should be made to the following detailed description, taken in connection with the accompanying drawings, in which:

FIG. 1 is a diagram of the system of the present invention adapted and programmed to perform, or assist in the performance of, each of the inventive method of FIG. 2;

FIG. 2 is a a block diagram of the inventive method; and

FIG. 3 is a block diagram of one embodiment of the inventive method of determining a combined property risk level score.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

Reference is now made to the figures wherein like parts are referred to by like numerals throughout. The present invention includes a system 10 and associated method 30 for managing risk associated with property. Examples of property for which risk could be managed could include collateral securing a secured loan or lease property leased under a lease agreement. In describing the present method, the general setting is that of a loan agreement between a borrower and a lender for a loan amount or that of a lease agreement between a lessee and a lessor for a lease amount. The borrower or lessee could be any individual or entity that enters into the loan agreement or lease agreement, respectively, and possesses the property. For this reason, the borrower or lessee could also be referred to as the possessor of the property.

Similarly, the lender is contemplated to be any individual or entity that loans the loan amount to the borrower under the loan agreement and a lessor is contemplated to be any individual or entity that leases the lease property to the lessee under the lease agreement, and consequently owns the property. For this reason, the lender or lessor could also be referred to as the owner of the property. The term “collateral” refers to the property securing the loan amount and the term “lease property” refer to the property leased to the lessee. “Collateral” and “lease property” could refer to any type of real or personal property, such as consumer goods, automobiles, or any other property.

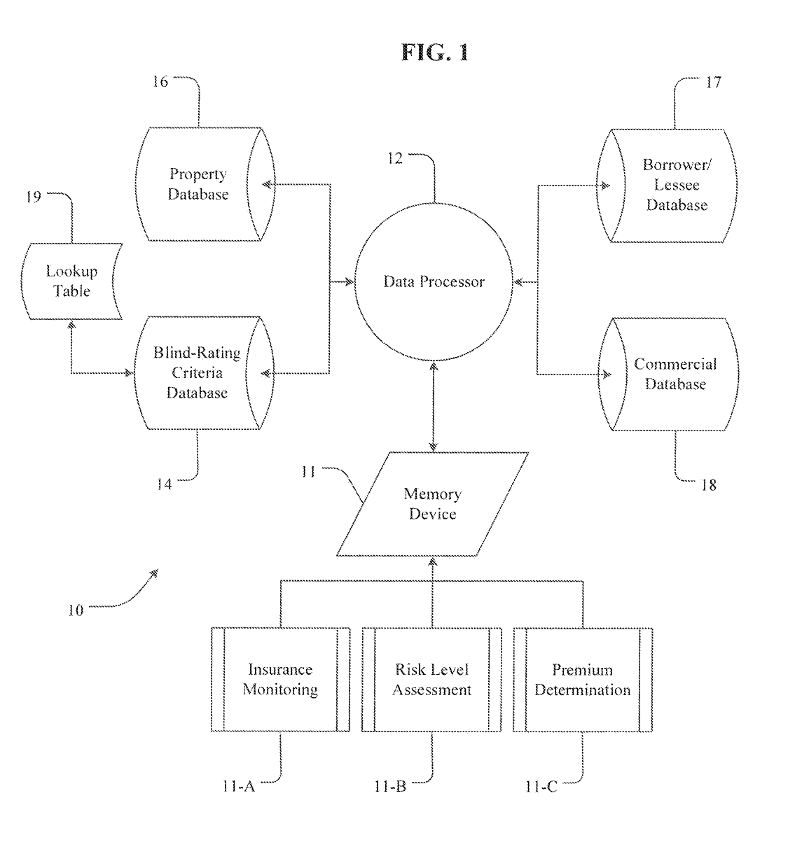

Referring to FIG. 1, a system 10 for implementing the inventive method 30 (discussed below) according to the present invention includes a memory device 11 and data processor 12. The memory device 11 may, according to some embodiments, store one or more of insurance monitoring instructions 11-A, risk level assessment instructions 11-B and insurance premium determination instructions 11-C. In some embodiments, the insurance monitoring instructions 11-A, risk level assessment instructions 11-B and insurance premium determination instructions 11-C may be utilized by the processor 12 to provide the necessary output information. The data processor 12 executes insurance monitoring instructions 11-A, risk level assessment instructions 11-B and insurance premium determination instructions 11-C in the form of software, firmware, or other executable or readable instructions. Accordingly, the insurance monitoring instructions 11-A, risk level assessment instructions 11-B and insurance premium determination instructions 11-C be operable to cause the data processor 12 to access and/or process information from the blind rating database 14, property database 16 and lookup table 19 (discussed below) as well as publicly and commercially available databases.

The data processor 12 may take any form including the CPU of a general purpose computer. The data processor 12 communicates with, and receives data from, at least one data structure storing a blind rating database 14 containing a plurality of blind rating criteria. Optionally, property database 16 contains information related to a particular property and/or a particular insured. Information in database 36 may include known information about the property as well as information relating to the transaction, such as the minimum level of insurance that must be maintained in force for the collateral property. Alternatively, system 10 can include a borrower/lessee database 17 to store information about the borrower/lessee (or such information can be stored in the property database 16) as well as third-party and/or commercial databases 18 which are known in the industry.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The blind rating database 14 and property database 16 may be stored together or separately on any data storage medium including magnetic storage, optical storage, electrical storage, flash storage, or any other type of data storage. Moreover, the blind rating database 34 and property database 36 could be stored locally or remotely and could be accessed by the data processor 32 through any means including through a data bus, modem, network connection, Internet connection, or any other data communication. In one optional embodiment, the blind rating database 14 is stored locally and the property database, such as any of the insurance databases generally accessible to the industry, is stored and/or accessed remotely.

System 30 is designed to implementing, via insurance monitoring instructions 11-A, the insurance status of the property to determine if it fails to meet a minimum standard. For example, the insurance status could fail to meet a minimum standard if an insurance policy covering damage to the collateral or lease property is not maintained as agreed. This could include lapse of insurance, but could also include such impairments to insurance as obtaining insurance with policy limits or deductibles different from the terms required under the loan or lease agreement.

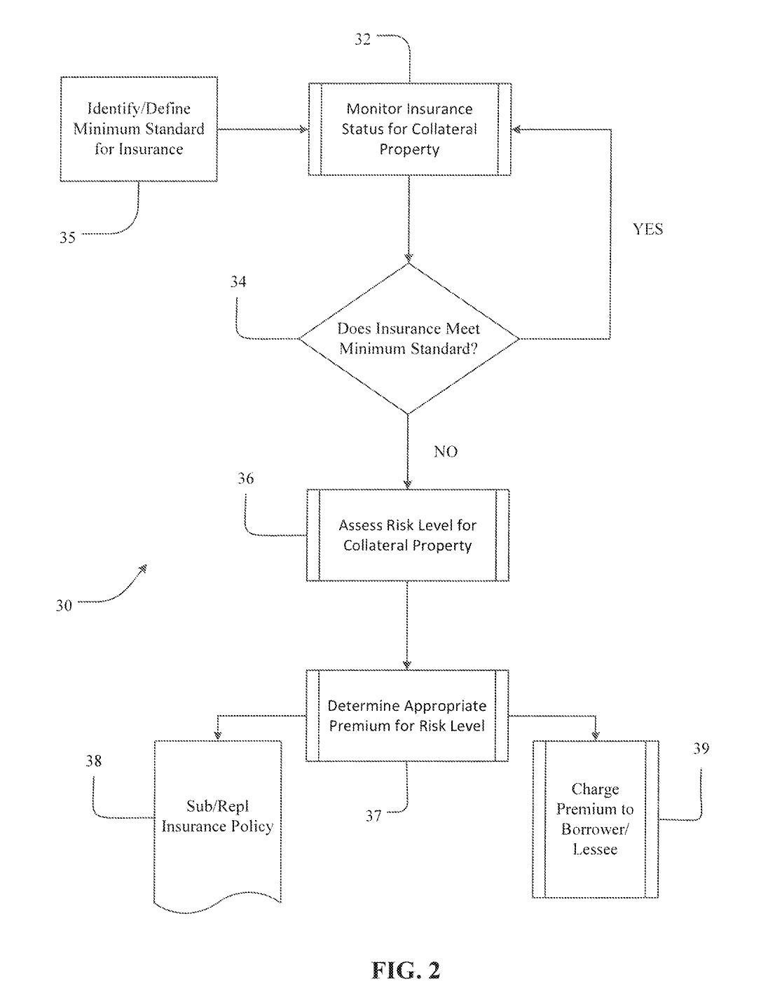

As seen in FIG. 2, a minimum standard for the insurance status is defined 35, and stored in property datable 16, and the insurance status of the property is monitored 32. Again, the property in question could be the property covered by the lender's loans or lessor's leases. Some specific examples of how this monitoring 32 may take place are given below. The monitoring 32 could occur in any fashion, including at continuous, regular periodic or irregular time intervals. In an optional embodiment, the monitoring 32 takes place at regular intervals, such as monthly.

The result of the monitoring 32 is a determination 34 whether the insurance status of the property meets a defined 35 minimum standard. For example, the monitoring 34 could determine whether the insurance policy on each piece of collateral securing the lender's loans is in force as agreed. If it is determined 34 that the insurance status of the property meets a minimum standard, i.e. the insurance policy on the collateral for any loan or lease property for any lease is still in force under the agreed terms, no action is taken and the monitoring 32 continues.

Conversely, if it is determined 34 that the insurance status of the property fails to meet a minimum standard, i.e. the insurance policy on the collateral for any loan or lease has lapsed or become impaired, a risk level assessment 36 is performed to determine the loss of risk to the collateral property. Once the risk level score is determined, a premium determination step 37 determines the appropriate premium for the insurance product 38 to insure the property. Premiums for the substitute/replacement policy 38 are charged to the lender/borrower (39). Stated another way, if a borrower allows the insurance on the collateral securing that borrower's loan to lapse or otherwise become impaired or a lessee allows the insurance on the lease property to lapse or otherwise become impaired, a “force placed” insurance is obtained with the premiums therefore being charged to the borrower or lessee.

Referring generally to FIGS. 1-3, the data processor 12 determines whether the collateral securing the loans or the lease property in the property database 16 is insured at appropriate levels (34) by monitoring 12 the insurance status of the collateral or lease property. While this could be accomplished in many different ways, in one optional embodiment, the data from the property database 16 is compared to the data from the insurance databases generally accessible to the industry. If the insurance status on the collateral for the loan, or the lease, in the property database 16 fails to meet the minimum standard because, for example, the insurance on the property has lapsed or otherwise become impaired, the loan associated with the uninsured or under-insured collateral, or the lease associated with the uninsured or under-insured lease property, is flagged for assessment 36 of the relevant risk level to determine the appropriate premium for a replacement or supplemental insurance product.

The invention includes a computer implemented method of evaluating risk in, and setting a corresponding premium, on a supplemental or replacement insurance product that meets the minimum insurance standard.

Blind rating, for purposes of the present application, refers to the method for evaluating risk in, and setting the premium on, an insurance product, without considering several factors that are normally obtained from the beneficiary of the product or the insured. For example, information specific to the insured or the insured property but not publicly available, such as income levels, credit ratings, lifestyle activities, nature of use of the property, physical condition of the property, and the like, are not considered under a blind rating method.

Information that is already known to the issuer of the insurance product, some public, some not, as well as publicly and commercially available information is used in the blind rating method. Examples of this information (hereinafter “blind rating criteria”) include, inter alia, geographic and geological information, assessed property values, claim history, flood risk data, values of surrounding properties, recent property sales, premiums charged for similarly situated properties, and the like. Optimally, blind rating database 14 is searchable to identify and allow selection of the blind rating criteria applicable to a particular property and/or a particular insured.

In an illustrative embodiment the blind rating criteria database 14 includes one or more geographical characteristics which can be associated with the physical location of the property. In accordance with the disclosed invention, risk level assessment instructions 11-B cause processor 12 to access blind rating database 14 which is populated with predetermined “blind rating criteria” associated with the property. Blind rating data and property data may, for example, be analyzed, sorted, filtered, decoded, decompressed, ranked, scored, plotted, and/or otherwise processed by the data processor 32 in accordance with the premium determination instructions 11-B.

The risk level assessment is conducted by calculating, for each selected blind rating criterion in blind rating database 14, a corresponding score that indicates a risk of loss at the property. The risk level is computed based on the blind rating criteria associated with the property.

The risk level assessment instructions 11-B can apply one or more risk models for each blind criterion based on information in the property database 16. As used herein, the term “model” refers to any operation that receives one or more input values and generates one or more output values based on the input value(s). Those skilled in the art will recognize that a model can be implemented by a “real-time” mathematical computation or by a look-up table that retrieves pre-computed values. Those skilled in the art will also recognize that risk of loss models can be generated from predictive analytic techniques, and/or other forward-looking or backward-looking actuarial data and/or techniques.

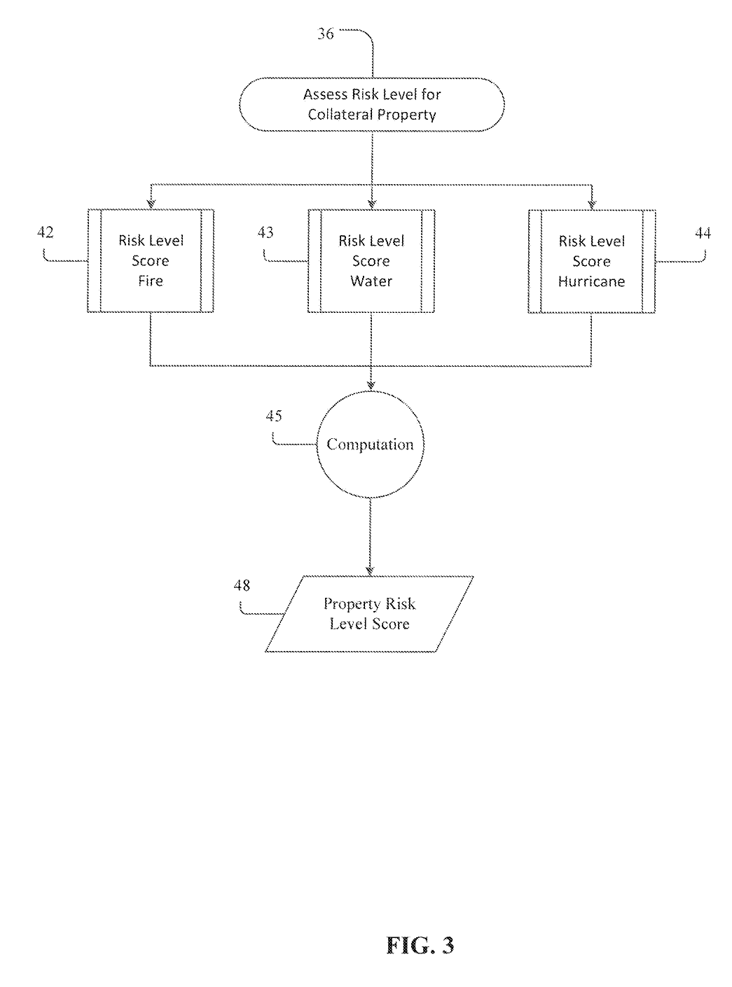

For example, risk level for the property from multiple threats (blind rating criterion) can be computed. Each risk computation can consider different types of blind rating criteria based on information relating to geographical characteristics. In the illustrated embodiment of FIG. 3, for example, risk level assessment 36 includes the determination of individual risk levels based on a risk level based on loss from fire 42, a risk level based on a loss from water 43, and a risk level based on loss from a hurricane 44, can each be computed.

The input value to to each risk of loss model in this example is the property address. In computation 42 the model can compute the distance between the address and areas of relatively high wildfire risk, and use the computed distance to determine risk of loss at the address from fire. The risk of loss at the address from water 43 can correlate the proximity/distance between the address and a coast, such as a lake, gulf, ocean, or other body of water. The risk of loss at the address from a hurricane 44 can correlate the latitude of the property in combination with the proximity/distance between the address and a coast, such as a gulf, sound or ocean.

With continuing reference to FIG. 3, the risk level scores for individual criterion (blocks 42-44) in blind rating database 14 are used by the data processor 12 in computation block 45 to generate a property risk level score 48. There are many ways to combine the various measures of risk corresponding to different blind rating criterion known to those of skill in the art. In one embodiment, the computation block 45 can compute a weighted sum of individual risk levels to be the property risk level score. The weights for each risk level can be a percentage value that indicates the percentage of paid insurance claims that involve the blind rating criterion.

In one embodiment, the individual risk levels are combined to form a combined risk level that indicates a combined risk of loss at the property. In this embodiment, the combined risk level is used to compute an insurance premium for property. In another embodiment, the highest individual risk level based on the blind rating criteria is used to compute an insurance premium for property. In still another embodiment, the individual risk levels are averaged to form an average risk level that indicates a combined risk of loss at the property. In this embodiment, the combined risk level is used to compute an insurance premium for property. The property risk level score can then be associated with the property and stored in the property database 16.

Alternatively, or in combination with the methodology described above, the property risk level score can be based on blind rating criteria based on historical and financial information related to the property. In this embodiment, the model(s) use the location of the property to identify, inter aria, historical insurance claim data, values of surrounding properties, recent property sales and premiums charged for similarly situated properties.

The minimum required level of insurance, individual blind rating criteria risk level scores and/or the property risk level score for the property may, for example, be analyzed, sorted, filtered, decoded, decompressed, ranked, scored, plotted, and/or otherwise processed by the data processor 12 in accordance with the premium determination instructions 11-C. In some embodiments, blind rating data, property data and risk levels may be fed by the data processor through one or more mathematical and/or statistical formulas, rule sets, policies, and/or models in accordance with the premium determination instructions 11-C to determine a rate quote that may then be utilized to facilitate insurance product configuration and/or underwriting and/or premiums.

Alternatively , the system 10 also includes a lookup table 19 which correlates a given property risk level score, or a range thereof, with an insurance premium value for that score and/or range. The premium determination instructions 11-C may be operable to cause the data processor 12 to access and/or process lookup table 19 to determine a rate quote that may then be utilized to facilitate insurance product configuration and/or underwriting and/or premiums.

Once the premium is determined and the appropriate insurance product is identified, the supplemental and/or replacement insurance product is obtained. Premiums for the supplemental and/or replacement insurance product are then charged to the borrower or lessee.

It should be noted that the system of the present invention is not necessarily a unitary system that is operated at a single location by a single operator. To the contrary, it is contemplated that one or more steps of the method 30 may be performed by affiliates to the lender or lessor, rather than the lender or lessor itself Thus, various portions of the system 10 may be utilized by an affiliate to the lender or lessor, while other portions of the system 10 may be utilized by the lender or lessor itself. For example, the lender or lessor could contract with an affiliate to monitor the insurance status of the collateral securing the loans while the lender or lessor itself handles the actual assessment and collection of the loan default or property protection fee. However, it is also noted that the present invention is not limited to any particular division of steps of the method 30 or elements of the system 10.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method of blind rating of a collateral property and setting of a premium for insurance of the collateral property, comprising:
a. communicating instructions by a system having a data processor to store property data in a first database;
b. storing among said property data an insurance status associated with said property wherein said insurance status indicates at least whether said property is in included in an insurance policy;
c. storing among said property data a minimum standard for said insurance status maintained by said possessor on said property;
d. monitoring by said data processor, to determine the insurance status of said property as maintained by said possessor on said property; and
e. when the insurance status of said property does not meet said minimum standard:
i. calculating, by said processor, a property risk level score ;
ii. correlating, by said processor, the property risk level score with a premium for an insurance policy, meeting the required minimum level of insurance stored; and
iii. issuing said insurance policy for the collateral property.

2. The method of claim I wherein said insurance status further identifies a policy limit of said insurance policy for said property and said minimum standard is a predefined value for said policy limit such that said insurance status would fail to meet said minimum standard if the insurance policy associated with said property in said insurance database has a policy limit that fails to meet said predefined value.

3. The method of claim 1 wherein;
a. said insurance status further indicates a deductible of said insurance policy for said property; and
b. said minimum standard includes a maximum quantity for said deductible.

4. The method of claim 1 wherein;
a. said insurance status further indicates a maximum benefit amount; and
b. said minimum standard includes a minimum quantity for said maximum benefit amount.

5. The method of claim 1 wherein said property risk level score is calculated using at least one risk level score for at least one of a plurality of blind rating criteria stored in a second database.

6. The method of claim 1 wherein calculating said property risk level score comprises calculating at least one risk level score for at least one of a plurality of blind rating criteria stored in a second database.

7. The method of claim 1 wherein calculating said property risk level score comprises:
a. calculating a risk level score for each of a plurality of blind rating criteria stored in a second database; and
b. selecting the highest of the plurality of risk level scores,

8. The method of claim I wherein calculating said property risk level score comprises:
a. calculating a risk level score for each of a plurality of blind rating criteria stored in a second database; and
b. averaging of the plurality of risk level scores.

9. The method of claim 1 wherein calculating said property risk level score comprises:
a. calculating a risk level score for each of a plurality of blind rating criteria stored in a second database; and
b. combining the plurality of risk level scores.

10. The method of claim 8, wherein in each of the plurality of blind rating criteria are weighted by said processor.

11. A computer system for the blind rating of a collateral property and setting of a premium for insurance of the collateral property, comprising
a. A processing device;
b. A first database containing information related to the collateral property including at least an insurance status and a minimum standard for insurance maintained by said possessor on the collateral property;
c. A second database containing information related to a plurality of predetermined blind rating criteria relating to the risk of loss at the collateral property;
d. A memory device containing instructions that when executed by the processing device result in:
i. Comparing the insurance status and the minimum standard for insurance;
ii. Calculating, responsive to the insurance status falling below the minimum standard for insurance, a property risk level score;
iii. Correlating the property risk level score to an insurance product that meets the minimum standard for insurance; and
iv. Obtaining the insurance product to cover the collateral property.

12. The computer system of claim 11, wherein the memory device contains instructions that when executed by the processor calculate the property risk level score using at least one of a plurality of blind rating criteria stored in a second database.

13. The computer system of claim 11, wherein the memory device contains instructions that when executed by the processor calculate the property risk level score by:
a. calculating a risk level score for each of a plurality of blind rating criteria stored in a second database: and
b. selecting the highest of the plurality of risk level scores.

14. The computer system of claim 11, wherein the memory device contains instructions that when executed by the processor calculate the property risk level score by:
a. calculating a risk level score for each of a plurality of blind rating criteria stored in a second database; and
b. averaging of the plurality of risk level scores.

15. The computer system of claim 11, wherein the memory device contains instructions that when executed by the processor calculate the property risk level score by:
a. calculating a risk level score for each of a plurality of blind rating criteria stored in a second database; and
b. combining the plurality of risk level scores.
